(19) United States
(12) Patent Application Publication
(10) Pub. No.: US 2014/0087082 A1
(43) Pub. Date: Mar. 27, 2014

(54) Room Temperature Vulcanisable Silicone Compositions

(71) Applicant: Dow Corning Corporation, Midland, MI (US)

(72) Inventors: Stephen Altum, Midland, MI (US); Aaron J. Seitz, Midland, MI (US)

(73) Assignee: Dow Corning Corporation, Midland, MI (US)

(21) Appl. No.: 14/122,099

(22) PCT Filed: May 29, 2012
(86) PCT No.: PCT/US2012/039794

§ 371 Date: Nov. 25, 2013

Related U.S. Application Data
(60) Provisional application No. 61/491,940, filed on Jun. 1, 2011.

(51) Int. Cl. C09D 183/04

(52) U.S. Cl. CPC C09D 183/04
USPC 427/387; 524/400; 524/268; 524/425

(57) ABSTRACT

Room temperature vulcanisable (RTV) silicone compositions which are storage stable, have good freeze/thaw characteristics in the absence of polar solvents and which cure to a low modulus silicone elastomer and a process for making same. The composition contains (i) 100 parts by weight of a hydroxyl endblocked polydiorganosiloxane having a viscosity at 25° C., of from 5 to 100 Pa·s (ii) one or more fillers, optionally treated to be rendered hydrophobic, (iii) from 2.5 to 10 parts by weight of methylvinyldi(N-ethylacetamido)silane, (iv) from 1 to 6 parts by weight of an aminoxysilicon compound having from 1 to 100 silicon atoms per molecule and from 3 to 10 aminoxy groups per molecule. The composition no i.e. zero (0) parts of a polar solvent selected from, N,N-dimethylformamide (DMF), acetonitrile and N-n-butylacetamide and does not visibly partially crystallize when stored at a temperature of 5° C. or less.

This relates to room temperature vulcanisable (RTV) silicone compositions which are storage stable, have good freeze/thaw characteristics in the absence of polar solvents and which cure to a low modulus silicone elastomer.

U.S. Pat. No. 3,817,909 describes silicone compositions which cure to low modulus silicone elastomers comprising:—(A) 100 parts by weight of a hydroxyl-terminated polydiorganosiloxane having a viscosity at 25° C. of from 30 to 50,000 cst, (B) 0 to 150 parts by weight of a non-acidic, non-reinforcing filler, (C) 2 to 20 parts by weight of an acetamidosilane of the general formula

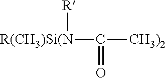

in which R is a methyl, vinyl or phenyl radical, and R′ is a methyl ethyl or phenyl radical, and (D) 0.25 to 7 parts by weight of an aminoxysilicon compound having from 1 to 100 silicon atoms per molecule and from 3 to 10 aminoxy groups per molecule, said aminoxy group having a general formula —OX in which X is either a monovalent amine radical or a heterocyclic amine.

The amidosilanes (C) were claimed under the general formula given above and whilst an extended list of possible acetamidosilanes (C) was provided in the description only dimethyldi(N-methylacetamido)silane, methylvinyldi(N-methylacetamido)silane were used in the examples.

U.S. Pat. No. 3,996,184 was subsequently filed and indicates that compositions depicted in the examples of U.S. Pat. No. 3,817,909 are stable and useful as described but a number of negative issues were identified, particularly with respect to their freeze-thaw characteristics and slump characteristics. This was because, according to U.S. Pat. No. 3,996,184, the compositions described in U.S. Pat. No. 3,817,909 “were found to form crystals when cooled below room temperature, such as to 5° C. for example”. The authors of U.S. Pat. No. 3,996,184 proposed that the crystals appeared “to be free amide which is formed by trace amounts of moisture and reaction with the silicon-bonded hydroxyl radicals in the composition. It is also observed that there is a relationship between the formation of crystals and the slump properties of the compositions. When crystals were present, the compositions would slump badly at low temperatures and the aesthetic appearance of the uncured sealant composition and ultimately the resulting elastomer is made worse”.

The solution provided in U.S. Pat. No. 3,996,184 to avoid the crystallization/slump problem identified was to introduce small amounts of polar solvents selected from N,N-dimethylformamide (DMF), acetonitrile and N-n-butylacetamide, with DMF preferred into the composition. Whilst this solution provided a composition which overcame the crystallization/slump issue, it introduced a further problem in that the introduction of such solvents, resulted in the composition having increased toxicity, volatile organic content (VOC) and potential problems from the leaching out of solvent(s) from the resulting cured elastomer which may cause damage to surfaces to which the sealant is applied or can dissolve paint on adjacent surfaces. In the significantly more environmentally aware world we live in today such compositions containing one or more of these solvents have to meet significantly more stringent regulations and are the subject of labeling requirements to meet national environmental requirements in countries around the world.

U.S. Pat. No. 5,017,628 describes a self-levelling silicone composition for use as an asphalt highway joint sealant which cures upon exposure to moisture which consists essentially of a hydroxyl endblocked polydiorganosiloxane (A), non-acidic, non-reinforcing treated filler B, diacetamido functional silane (C), an aminosiloxane cross-linker (D) and a non-reactive silicone fluid diluent (E). The diacetamido functional silane (C) is of the general formula:

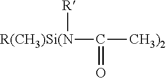

in which R is a vinyl radical, and R′ is a methyl ethyl or phenyl radical. U.S. Pat. No. 5,017,628 also required that the diacetamido functional silane (C) and said aminoxysilicon compound were “present in amounts sufficient to provide a combined weight of at least 5 parts by weight per 100 parts by weight of polymer, and said aminoxysilicon compound being present in an amount which is not greater than the weight of the diacetamido functional silane (C), said composition being self levelling when applied to a surface and, when cured for fourteen days at 25° C. exposed to an air atmosphere having 50% relative humidity, resulting in a silicone elastomer having an elongation of at least 1200% and a modulus at both 50 and 100% elongation of less than 25 pounds per square inch (psi). However, U.S. Pat. No. 5,017,628 is silent regarding the crystallization issue discussed above but advocates the optional use of the solvents discussed in U.S. Pat. No. 3,996,184. Furthermore, in the examples of U.S. Pat. No. 5,017,628 the only acetamido functional silane used was methylvinyldi(N-methylacetamido)silane, the temperatures used were always room temperature and examples 4 and 7 both require the addition of N,N-dimethylformamide. Hence, the only acetamido functional silane used in the prior art examples, other than Example 3 of U.S. Pat. No. 3,817,909 was methylvinyldi(N-methylacetamido)silane and Example 3 of U.S. Pat. No. 3,817,909 used dimethyldi(N-methylacetamido)silane in its place. Hence, no N-alkylacetamido group other than N-methylacetamido has been used in any examples and both U.S. Pat. No. 3,996,184 and U.S. Pat. No. 5,017,628 advocate the need for a solvent such as DMF.

It has now been identified that the previously taught essential polar solvent as described in U.S. Pat. No. 3,996,184 used to avoid freeze thaw issues is not required when the acetamido functional silane chosen is methylvinyldi(N-ethylacetamido)silane, thereby avoiding the problems caused by the freeze/thaw issues of acetamido functional silanes or alternatively and the with use of polar solvents such as DMF in combination with acetamido functional silane which is a significant advantage for the user when compared to the previous incorporation of such solvents.

In accordance with the present disclosure there is provided a silicone elastomer composition which is storage stable, at temperatures of 5° C. or below, alternatively 0° C. or below, in the absence of moisture but curable at room temperature, upon exposure to moisture, to a silicone elastomer which composition consists essentially of a mixture prepared by mixing under anhydrous conditions:
(i) 100 parts by weight of a hydroxyl endblocked polydiorganosiloxane having a viscosity at 25° C., of from 5 to 100 Pa·s and in which the organic groups are selected from the group consisting of methyl, ethyl, vinyl, phenyl, and 3,3,3-trifluoropropyl radicals, with the provisos that no more than 50% of the organic groups are phenyl radicals or 3,3,3-trifluoropropyl radicals and no more than 10% of the organic groups are alkenyl radicals,
(ii) one or more fillers, optionally treated to be rendered hydrophobic,
(iii) from 2.5 to 10 parts by weight of methylvinyldi(N-ethylacetamido)silane,
(iv) from 1 to 6 parts by weight of an aminoxysilicon compound having from 1 to 100 silicon atoms per molecule and from 3 to 10 aminoxy groups per molecule, said aminoxy group having a general formula —OX in which:
   X is a monovalent amine radical selected from the group consisting of —NR₂ and a heterocyclic amine and R is a monovalent hydrocarbon radical,
   said —OX group being bonded to silicon atoms through an SiO bond, the remaining valences of the silicon atoms in the aminoxysilicon compound being satisfied by divalent oxygen atoms which link the silicon atoms of the aminoxysilicon compounds having two or more silicon atoms per molecule through silicon-oxygen-silicon bonds and by monovalent hydrocarbon radicals and halogenated monovalent hydrocarbon radicals bonded to the silicon atoms through silicon-carbon bonds, there being an average of at least one monovalent hydrocarbon radical or halogenated monovalent hydrocarbon radical per silicon atom;
      characterised in that the composition contains no i.e. zero (0) parts of a polar solvent selected from, N,N-dimethylformamide (DMF), acetonitrile and N-n-butylacetamide and does not visibly partially crystallize when stored at a temperature of 5° C. or less.

In a further embodiment there is provided a use of methylvinyldi(N-ethylacetamido)silane (iii) in a silicone elastomer composition which is storage stable, at temperatures of 5° C. or below, alternatively 0° C. or below, in the absence of moisture but curable at room temperature, upon exposure to moisture, to a silicone elastomer consists essentially of a mixture prepared by mixing under anhydrous conditions:
(i) 100 parts by weight of a hydroxyl endblocked polydiorganosiloxane having a viscosity at 25° C., of from 5 to 100 Pa·s and in which the organic groups are selected from the group consisting of methyl, ethyl, vinyl, phenyl, and 3,3,3-trifluoropropyl radicals, with the provisos that no more than 50% of the organic groups are phenyl radicals or 3,3,3-trifluoropropyl radicals and no more than 10% of the organic groups are alkenyl radicals,
(ii) one or more fillers, optionally treated to be rendered hydrophobic,
(iii) from 2.5 to 10 parts by weight of said methylvinyldi(N-ethylacetamido)silane,
(iv) from 1 to 6 parts by weight of an aminoxysilicon compound having from 1 to 100 silicon atoms per molecule and from 3 to 10 aminoxy groups per molecule, said aminoxy group having a general formula —OX in which:
   X is a monovalent amine radical selected from the group consisting of —NR₂ and a heterocyclic amine and R is a monovalent hydrocarbon radical,
   said —OX group being bonded to silicon atoms through an SiO bond, the remaining valences of the silicon atoms in the aminoxysilicon compound being satisfied by divalent oxygen atoms which link the silicon atoms of the aminoxysilicon compounds having two or more silicon atoms per molecule through silicon-oxygen-silicon bonds and by monovalent hydrocarbon radicals and halogenated monovalent hydrocarbon radicals bonded to the silicon atoms through silicon-carbon bonds, there being an average of at least one monovalent hydrocarbon radical or halogenated monovalent hydrocarbon radical per silicon atom;
      characterised in that the composition contains no i.e. zero (0) parts of a polar solvent selected from, N,N-dimethylformamide (DMF), acetonitrile and N-n-butylacetamide and does not visibly partially crystallize when stored at a temperature of 5° C. or less.

The hydroxyl endblocked polydiorganosiloxanes (i) can have a viscosity at 25° C. of from about 5 to 100 Pa·s. These polydiorganosiloxane can be monodispersed, polydispersed, or blends of varying viscosities as long as the average viscosity falls within the limits defined above. The hydroxyl endblocked polydiorganosiloxanes have organic groups selected from methyl, ethyl, vinyl, phenyl and 3.3.3-trifluoropropyl radicals. The organic groups of the polydiorganosiloxane contain no more than 50% phenyl or 3,3,3-trifluoropropyl radicals and no more than 10% vinyl radicals based upon the total number of radicals in the polydiorganosiloxane. Other monovalent hydrocarbon radicals and halogenated monovalent hydrocarbon radicals in small amounts can be present in the polydiorganosiloxane. The diorganosiloxane units of the hydroxyl endblocked polydiorganosiloxane can be, for example, dimethylsiloxane, diethylsiloxane, ethylmethylsiloxane, diphenylsiloxane, methylphenylsiloxane, methylvinylsiloxane, and 3,3,3-trifluoropropylmethylsiloxane or alternatively a mixture of two or more of the units above. Most preferably The hydroxyl endblocked polydiorganosiloxanes is a polydimethylsiloxane have a viscosity at 25° C. of from about 5 to 100 Pa·s,

The term polydiorganosiloxane as used herein does not preclude small amounts of other siloxane units such as monoorganosiloxane units. The hydroxyl endblocked polydiorganosiloxanes are known in the art and can be made by known commercial methods. The preferred hydroxyl endblocked polydiorganosiloxane is hydroxyl endblocked polydimethylsiloxane.

Unless otherwise indicated all viscosity measurements herein are made at 25° C. in accordance with the ASTM D4287 Cone and Plate Method.

The compositions as described herein contain from 25 to 200 parts by weight of one or more (optionally non-acidic) fillers (ii) per 100 parts by weight of hydroxyl endblocked polydiorganosiloxane (i). Compositions will typically contain one or more finely divided, reinforcing fillers such as high surface area fumed and precipitated silicas including rice hull ash and to a degree calcium carbonate as discussed above, or additional non-reinforcing fillers such as crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, magnesium carbonate, clays such as kaolin, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃.2SiO₂; kyanite; and Al₂SiO₅.

The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

The sheet silicates group comprises silicate minerals, such as but not limited to, mica; K₂Al₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite.

In addition, a surface treatment of the filler(s) may be performed, for example with a fatty acid or a fatty acid ester such as a stearate ester, stearic acid, salts of stearic acid, calcium stearate and carboxylatepolybutadiene. Treating agents based on silicon containing materials may include organosilanes, organosiloxanes, or organosilazanes hexaalkyl disilazane or short chain siloxane diols to render the filler(s) hydrophobic and therefore easier to handle and obtain a homogeneous mixture with the other sealant components. The surface treatment of the fillers makes the ground silicate minerals easily wetted by the silicone polymer. These surface modified fillers do not clump, and can be homogeneously incorporated into the silicone polymer. This results in improved room temperature mechanical properties of the uncured compositions. Furthermore, the surface treated fillers give a lower conductivity than untreated or raw material.

In the case of self-levelling sealant formulations the compositions herein are preferably non-acidic, non-reinforcing fillers (ii), optionally having an average particle size of from 1 to 8 μm. For said self-levelling sealant formulations the preferred fillers may be selected from, for example, calcium carbonate, ferric oxide, diatomaceous earth, alumina, hydrated alumina, titanium dioxide, organic fillers, resins such as silicone resins, crushed quartz, calcium sulfate, and the like.

The proportion of such fillers when employed will depend on the properties desired in the elastomer-forming composition and the cured elastomer. Usually the filler content of the composition will reside within the range from about 5 to about 800 parts by weight, preferably from 25 to 400 parts by weight per 100 parts by weight of the polymer excluding the diluent portion. Self-levelling sealant formulations as described herein may for example contain from 25 to 125 parts by weight of the preferred non-acidic, non-reinforcing filler.

The filler is treated with the treating agent by either coating or reacting the filler with the treating agent. Treated fillers are commercially available, such as the calcium stearate treated calcium carbonate filler that is known as GAMA-SPERSE® C-11 also sold by Imerys of Roswell, Ga., and the Kotamite from Cyprus Industrial Minerals Company of Englewood, Colo. The filler is required to be treated because treated filler gives a higher flow to the uncured composition and a lower modulus to the cured composition.

Component (iii) is Methylvinyldi-(N-ethylacetamido)silane

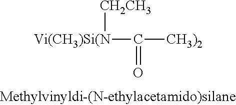

Methylvinyldi-(N-ethylacetamido)silane is utilized herein as a chain extender in that it reacts with the hydroxyl endblocked polydiorganosiloxane (i) to give a longer polymer. The polymer chain extension provides a polymer with an extended chain length which provides the resulting cured elastomer with a low modulus. The amount of methylvinyldi-(N-ethylacetamido)silane (iii) can be from 2.5 to 10 parts by weight per 100 parts by weight of polydiorganosiloxane polymer. The most preferred compositions have from 4 to 8 parts by weight per 100 parts by weight of polydiorganosiloxane polymer(i). When the amount of Methylvinyldi-(N-ethylacetamido)silane is less than 2.5 parts, the resulting composition cures to a silicone elastomer with sufficiently higher modulus so that it would no longer be classified as a low modulus silicone elastomer. The compositions can be packaged with all the reactive ingredients in one package and stored over extended periods of time under anhydrous condition, such as for three months or more. No advantages are experienced in exceeding 10 parts by weight because slower cures and less desirable physical properties are observed.

The aminoxysilicon compounds (iv) may be silicon compounds having from 1 to 100 silicon atoms per molecule in which there are from 2 to 20, alternatively 3 to 10, aminoxy groups per molecule. The aminoxy silicon compounds include silanes and siloxanes. The aminoxy group which is bonded to the silicon atoms through silicon-oxygen bonds can be represented by the general formula —OX wherein X is a monovalent amine radical of the group —NR₂ and heterocyclic amine and R represents a monovalent hydrocarbon radical.

The —NR₂ groups can be represented by N,N-diethylamino, N,N-ethylmethylamino, N,N-dimethylamino, N,N-diisopropylamino, N,N,-dipropylamino, N,N,-dibutylamino, N,N,-dipentylamino, N,N,-dihexylamino N,N,-dibutylamino, N,N-methylpropylamino, N,N,-diphenylamino, and N,N,-methylphenylamino. The heterocyclic amines can be illustrated by ethyleneimino, pyrrolidino, piperidino, and morpholino. Additional aminoxysilicon compounds are discussed in U.S. Pat. No. 3,996,184 which is hereby incorporated by reference to show aminoxysilicon compounds.

The aminoxysilicon compounds having one silicon atom are silanes having 3 aminoxy groups and one monovalent hydrocarbon radical or halogenated monovalent hydrocarbon radical per molecule. These aminoxy silanes have a general formula

R″Si(OX)₃

in which R″ may be a monovalent hydrocarbon radical or halogenated monovalent hydrocarbon radical. Examples of R″ may therefore be illustrated by methyl, ethyl, phenyl, vinyl, hexyl, octadecyl, cyclohexyl, butyl, heptyl, octyl, benzyl, phenylethyl, naphthyl, propyl, isopropyl, chlorophenyl, 3,3,3-trifluoropropyl, beta-(perfluoropentyl)ethyl, iodonaphthyl, bromoheptyl and the like.

The aminoxysilicon compounds which have more than one silicon atom per molecule can be linear polysiloxanes and cyclic polysiloxanes, for example, either homopolymers or copolymers or mixtures of the siloxanes as well as mixtures of the siloxanes and silanes. The silicon atoms of the siloxanes are linked together through silicon-oxygen-silicon bonds with the remaining valences of the silicon atoms not bonded to aminoxy groups being bonded to monovalent radicals as defined by R″ above. A preferred aminoxysilicon compound is a copolymer having an average of two trimethylsiloxane units, 2 to 20 methyl (N,N-dialkylaminoxy)siloxane units and 2 to 20 dialkylsiloxane units or alternatively an average of two trimethylsiloxane units, five methyl(N,N-diethylaminoxy)siloxane units and three dimethylsiloxane units per molecule as depicted in the Examples below.

The amount of aminoxysilicon compound (iv) may be from 0.5 to 10 parts by weight per 100 parts by weight of hydroxyl endblocked polydiorganosiloxane, alternatively 1 to 6 parts by weight per 100 parts by weight of hydroxyl endblocked polydiorganosiloxane. If the amount of aminoxysilicon compound exceeds 10 parts, the resulting cured products are high modulus silicone elastomers. The preferred amount of aminoxysilicon compound is from 2 to 5 parts.

Other conventional additives can be used so long as they are compatible with the remaining constituents of the composition including pigments, adhesion promoters, diluents, extrusion aids, catalysts, dyes, antioxidants, heat stability additives, and the like.

For example the diluent may be used in self-levelling compositions. When present the diluent may comprise from 1 to 20 percent by weight of the total composition of a diluent consisting of non-reactive silicone fluid having a viscosity of from 1 to 100 Pa·s at 25° C., alternatively 12 to 100 Pa·s at 25° C. or alternatively a trimethylsilyl endblocked polydimethylsiloxane having a viscosity of about 12 to 25 Pa·s at 25° C. The non-reactive silicone fluid can be a homopolymer of R″₂SiO units where R″ is methyl, ethyl, propyl, vinyl, or 3,3,3,-trifluoropropyl, and R″ can be the same or different in each unit. The end blocking unit of the silicone diluent can be R″₃SiO where R″ is as described above. The diluent is used to give a lower modulus and a higher elongation than can be achieved without the diluent. If the viscosity of the diluent is too low, the composition does not cure properly, that is, the tack free time becomes excessive. The diluent having a higher viscosity, 12 Pa·s and above for example, appear to give a shorter tack free time than the lower viscosity material. The amount of diluent required is less for the higher viscosity material than for the lower viscosity.

The amounts of the ingredients used in the composition described herein are chosen so that the composition, when cured for 14 days at 25° C. exposed to air having 50% relative humidity, results in a cured silicone elastomer having an elongation of at least 1200%, and a modulus at 50% and 100% elongation of less than 25 psi (172.4 kPa) as tested in accordance with ASTM D412. If the cured sealant does not meet these requirements, it does not function properly when used as a sealant in asphalt pavement; that is, the sealant will cause the asphalt to fail cohesively and thereby destroy the seal when the joint is exposed to tensile forces, such as those found when the asphalt contracts in cold weather.

The compositions are preferably made by mixing the hydroxyl endblocked polydiorganosiloxane and filler to make a homogeneous mixture with the filler well dispersed. A suitable mixture can usually be obtained in one hour using commercial mixers. The resulting mixture is preferably de-aired and then a mixture of methylvinyldi-(N-ethylacetamido)silane (iii) and aminoxysilicon compound (iv) is added and mixed with the polymer and filler mixture. This mixing is done under essentially anhydrous conditions. Then the resulting composition is put into containers for storage under essentially anhydrous conditions. Once one package compositions are made, they are stable; that is they do not cure, if the essentially moisture free conditions are maintained, but will cure to low modulus silicone elastomers when exposed to moisture at room temperature. A diluent or other additives may be mixed into the composition in any manner and at any time during the preparation, but it is preferred to add them after the polymer and filler have been mixed as a better filler dispersion takes place. Although the present compositions are designed as one package compositions, the components could be packaged in two or more packages, if desired.

The composition herein provides a sealant material which may provided in either a non-sag formulation or in a self-levelling formulation. A self levelling formulation means it is be “self-levelling” when extruded from the storage container into a horizontal joint; that is, the sealant will flow under the force of gravity sufficiently to provide intimate contact between the sealant and the sides of the joint space. This allows maximum adhesion of the sealant to the joint surface to take place. The self-levelling also does away with the necessity of tooling the sealant after it is placed into the joint, such as is required with a sealant which is designed for use in both horizontal and vertical joints. A non-sag composition unlike the latter typically will not visibly flow under the force of gravity and typically needs tooling into the position/joint which it is intended to seal.

The compositions disclosed herein do not require a catalyst to aid in curing the composition although suitable catalysts may be used if appropriate. However, many of the conventional curing catalysts used in room temperature vulcanizable silicone elastomer compositions are detrimental to the curing of the compositions.

Self levelling compositions as described herein are useful as a sealant having the unique combination of properties required to function in the sealing of asphalt pavement. Asphalt paving material is used to form asphalt highways by building up an appreciable thickness of material, such as 20.32 cm, and for rehabilitating deteriorating concrete highways by overlaying with a layer such as 10.16 cm. Asphalt overlays undergo a phenomena known as reflection cracking in which cracks form in the asphalt overlay due to the movement of the underlying concrete at the joints present in the concrete. These reflection cracks need to be sealed to prevent the intrusion of water into the crack, which will cause further destruction of the asphalt pavement when the water freezes and expands.

In order to form an effective seal for cracks that are subjected to movement for any reason, such as thermal expansion and contraction, the seal material must bond to the interface at the sidewall of the crack and must not fail cohesively when the crack compresses and expands. In the case of the asphalt pavement, the sealant must not exert enough strain on the asphalt at the interface to cause the asphalt itself to fail; that is, the modulus of the sealant must be low enough that the stress applied at the bondline is well below the yield strength of the asphalt.

An additional feature of a highway sealant which has been found to be desirable is the ability of the sealant to flow out upon application into the crack. If the sealant has sufficient flow, under the force of gravity, it will form an intimate contact with the sides of the irregular crack walls and form a good bond; without the necessity of tooling the sealant after it is extruded into the crack, in order to mechanically force it into contact with the crack sidewalls. This property will be referred to as self-levelling.

The modulus of the cured material is designed to be low enough so that it does not exert sufficient force on the asphalt to cause the asphalt to fail cohesively. The cured material is such that when it is put under tension, the level of stress caused by the tension decreases with time so that the joint is not subjected to high stress levels, even if the elongation is severe.

The following examples are included for illustrative purposes only and should not be construed as limiting the disclosure herein which is properly set forth in the appended claims. Parts are parts by weight. Viscosity measurements are given at 25° C. and were measured in accordance with the ASTM D4287 Cone and Plate Method unless otherwise indicated. 1 Pound per square inch (psi) is 6.895 kPa.

The associated Figures are provided herewith and depict as follows:

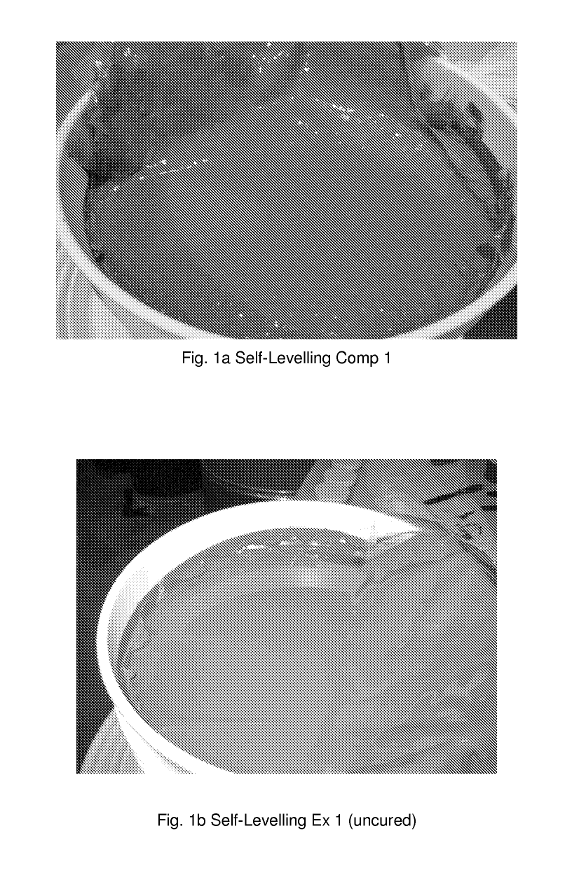

FIG. 1 a Self-Levelling Comp 1 showing grainy appearance due to the crystallization effect after COLD STORAGE for 6 months in unheated barn in Michigan winter, typically at temperatures between 0 and −10° C.

FIG. 1b Self-Levelling Ex 1 (uncured) showing smooth appearance after COLD STORAGE for 6 months in unheated barn in Michigan winter typically, at temperatures between 0 and −10° C.

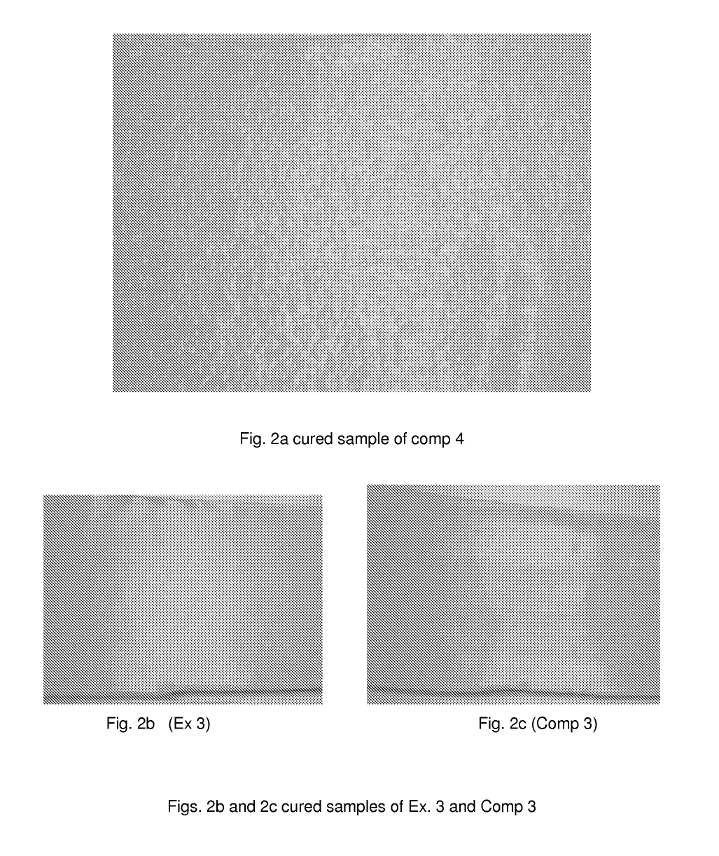

FIG. 2a cured sample of comp 4 showing grainy appearance due to the crystallization effect after COLD STORAGE: for 8 days @−30° C.

FIGS. 2b and 2c cured samples of Ex. 3 and Comp 3 (which includes DMF) showing

TABLE 1a
Compositions used in the following examples

| | | Self | | |
|---|---|---|---|---|
| | Self-Levelling | Levelling | Non-sag | Non-Sag |
| | Comp 1 | Example 1 | Comp 2 | Example 2 |
| Siloxane Polymer | 47.33 | 47.33 | 42.61 | 42.61 |
| NMA | 2.66 | | 2.35 | |
| NEA | | 2.71 | | 2.74 |
| aminoxysilicon | 1.37 | 1.37 | 1.58 | 1.36 |
| DMF | | | 0.69 | |
| Ground CaCO₃ | | | 53.26 | 53.26 |
| Treated ground | 37.86 | 37.86 | | |
| CaCO₃ | | | | |
| Diluent | 10.6 | 10.6 | | |

All formulations are given in parts by weight and all viscosities were measured at 25° C. unless otherwise indicated. The siloxane polymer is a dimethylhydroxy terminated dimethyl siloxane having a viscosity of 50 000 mPa·s (measured in accordance with the ASTM D4287 Cone and Plate Method). NMA is Methylvinylbis(N-methylacetamido)silane. NEA is MethylVinyl Bis(N-ethylacetamido)Silane. DMF is dimethyl formamide. The ground calcium carbonate was sold under the product name Atomite® sold by Imerys of Roswell, Ga. and according to the data sheet at the time of writing comprised ground calcium carbonate having a median particle size of 3.0 μm, a specific surface area of 2.8 m²g and a Moh hardness of 3. The treated ground calcium carbonate was GAMA-SPERSE® C-11 also sold by Imerys of Roswell, Ga.

The diluent was a non-reactive trimethylsilyl terminated dimethylsiloxane fluid having a viscosity of from 12500 mPa·s at 25° C. The aminoxysilicon compound used had the following general formula although it is to be noted that the groups on the backbone of the polymer may be in block form or randomly distributed.

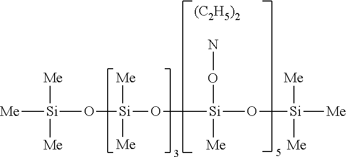

The compositions were allowed to cure and then were tested for their physical properties and the results are provided in Tables 1b and 1c below. The following test methods were utilized to obtain the results:

Duro (points) was measured in accordance with ASTM C661. Tensile strength, elongation, Modulus at 50% elongation (Modulus 50), modulus at 100% elongation (modulus 100) and modulus at 150% (modulus 150) were all measured in accordance with ASTM D412. Slump was measured (to the nearest 0.1 inches (0.25 cm)) in accordance with ASTM D2202. The Initial separation test (used in Example 2) is a visual inspection to identify whether or not a clear liquid can be observed pooling at the surface of uncured samples.

Analysis of Tables 1b and 1c indicate that whilst physical properties of the 2 self-levelling compositions are similar before and after cold storage the appearance of the example in accordance with invention is significantly superior due to the absence of the partially crystallized material rendering the product grainy. FIG. 1a depicts self-levelling Comp 1 showing grainy appearance due to the crystallization effect after cold storage for 6 months in an unheated barn in Michigan winter (typically at temperatures between 0 and −10° C.). FIG. 1b depicts Self-Levelling Ex 1 (uncured) showing the smooth appearance after cold storage for 6 months said unheated barn in Michigan winter (typically, at temperatures between 0 and −10° C.).

However in the case of the non-sag samples not only was crystallization avoided in the composition in accordance with the invention, a significant difference in elongation is evident after long term storage at a temperature averaging about −10° C. Hence, not only is the crystallisation issue avoided without the need of additional solvents such as DMF, but the example in accordance with the present invention has an additional significantly superior physical property.

TABLE 1b

| | Trial Data | | | |
|---|---|---|---|---|
| | self-levelling | | | |
| | formulations | | nonsag formulations | |
| | Self- | Self | Non- | Non- |
| | Levelling | Levelling | sag | Sag |
| description | Comp 1 | Example 1 | Comp 2 | Example 2 |

“FRESH”
RT sample preparation - 7 d cure

| | | | | |
|---|---|---|---|---|
| Duro (points) | 1 | 3 | 18 | 15 |
| Tensile strength (psi) (kPa) | 43 (296.5) | 40 (275.8) | 144 (992.9) | 133 (917.0) |
| Elongation at Break (%) | 2355 | 2350 | 2343 | 2549 |
| Modulus 50 (psi) (kPa) | 5 (34.48) | 5 (34.48) | 27 (186.17) | 26 (179.27) |
| Modulus 100 (psi) (kPa) | 6 (41.37) | 6 (41.37) | 30 (206.85) | 28 (193.06) |
| Modulus 150 (psi) (kPa) | 7 (48.27) | 7 (48.27) | 33 (227.54) | 29 (199.96) |

RT sample preparation - 21 d cure

| | | | | |
|---|---|---|---|---|
| Duro (points) | 3 | 3 | 17 | 18 |
| Tensile strength (psi) (kPa) | 47 (324.07) | 49 (337.86) | 143 (985.99) | 147 (1013.57) |
| Elongation at Break (%) | 2563 | 2527 | 2263 | 2502 |
| Modulus 50 (psi) (kPa) | 6 (41.37) | 7 (48.27) | 25 (172.38) | 26 (179.27) |
| Modulus 100 (psi) (kPa) | 7 (48.27) | 8 (55.16) | 28 (193.06) | 29 (199.96) |
| Modulus 150 (psi) (kPa) | 8 (55.16) | 8 (55.16) | 31 (213.75) | 31 (213.75) |

TABLE 1c

| | Trial Data | | | |
|---|---|---|---|---|
| | self-levelling | | | |
| | formulations | | | |
| | Self- | Self | nonsag formulations | |
| | Levelling | Levelling | Non-sag | Non-Sag |
| description | Comp 1 | Example 1 | Comp 2 | Example 2 |

“COLD STORAGE - 6 months in unheated barn in Michigan winter”
Initial - testing completed at cold temperatures

| | | | | |
|---|---|---|---|---|
| Appearance | grainy | smooth | grainy | smooth |

RT sample preparation - 7 d cure

| | | | | |
|---|---|---|---|---|
| Duro (points) | 2 | 1 | 15 | 17 |
| Tensile strength (psi) (kPa) | 48 (331) | 33 (227.54) | 98 (675.7) | 111 |
| | | | | (765.4) |
| Elongation at Break (%) | 2400 | 2343 | 1515 | 2169 |
| Modulus 50 (psi) (kPa) | 5 (34.48) | 4 (27.58) | 22 (151.69) | 23 |
| | | | | (158.59) |
| Modulus 100 (psi) (kPa) | 6 (41.37) | 5 (34.48) | 26 (179.27) | 25 |
| | | | | (172.38) |
| Modulus 150 (psi) (kPa) | 7 (48.27) | 6 (41.37) | 29 (199.96) | 27 |
| | | | | (186.17) |
| Slump (in) | NA | NA | 0 | 0 |

RT sample preparation - 21 d cure

| | | | | |
|---|---|---|---|---|
| Duro (points) | 3 | 1 | 15 | 16 |
| Tensile strength (psi) (kPa) | 43 (296.49) | 34 (234.43) | 98 (675.71) | 97 |
| | | | | (668.82) |
| Elongation at Break (%) | 2259 | 2076 | 1471 | 1836 |
| Modulus 50 (psi) (kPa) | 5 (34.48) | 5 (34.48) | 23 (158.59) | 22 |
| | | | | (151.69) |
| Modulus 100 (psi) (kPa) | 6 (41.37) | 6 (41.37) | 27 (186.17) | 25 |
| | | | | (172.38) |
| Modulus 150 (psi) (kPa) | 7 (48.27) | 6 (41.37) | 30 (206.85) | 27 |
| | | | | (186.17) |

### EXAMPLE 2

Further non-sag samples were prepared and tested in Example 2 below. The formulations of the compositions are indicated in table 2a and the physical property results are provided in Tables 2b and 2c. The same components were used as those in Example 1. The same test methods were utilized as defined above.

TABLE 2a

| | Comp 3 | Comp 4 | Example 3 |
|---|---|---|---|
| Siloxane polymer | 42.61 | 42.61 | 41.07 |
| Ground CaCO₃ | 53.26 | 53.26 | 52.66 |
| DMF | 0.69 | | |
| aminoxysilicon | 1.58 | 1.58 | 1.58 |
| NMA | 2.35 | 2.35 | |
| NEA | | | 2.19 |

TABLE 2b

| Trial Data | | |
|---|---|---|
| Non sag formulations | | |
| Comp 3 | Comp 4 | Example 3 |

“FRESH”
Room temperature sample preparation - 7 day cure

| | | | |
|---|---|---|---|
| Duro (points) | 15 | 16 | 17 |
| Tensile strength (psi) (kPa) | 132.149 | 149.673 | 153.263 |
| | (911.17) | (1032.00) | (1056.75) |
| Elongation at Break (%) | 2037.603 | 2158.361 | 2084.72 |
| Modulus 50 (psi) (kPa) | 26.727 | 27.006 | 30.421 |
| | (184.28) | (186.21) | (209.75) |
| Modulus 100 (psi) (kPa) | 29.95 | 31.416 | 34.461 |
| | (206.51) | (216.61) | (237.61) |
| Modulus 150 (psi) (kPa) | 32.736 | 34.858 | 37.874 |
| | (225.71) | (240.35) | (261.14) |

In this example samples were cured for 7 days at room temperature prior to physical property testing. It is noted that the fresh samples each appear to have reasonably equal physical properties after room temperature cure which is perhaps to be expected.

TABLE 2c
Cold storage: 8 days @ −30° C.

| Initial | Comp 3 | Comp 4 | Example 3 |
|---|---|---|---|
| Cold appearance | smooth | grainy | smooth |
| Initial separation | yes - clear fluid | yes - clear fluid | none |
| Slump (in) | 0.05 | 0.15 | 0.05 |

TABLE 2d
Cold sample preparation - 7 day cure @ RT

| Initial | Comp 3 | Comp 4 | Example 3 |
|---|---|---|---|
| Duro (points) | 16 | 17 | 17 |
| Tensile strength (psi) (kPa) | 147.188 | 130.806 | 152.473 |
| | (1014.86) | (901.91) | (1051.30) |
| Elongation at Break (%) | 2108.936 | 1901.592 | 2034.11 |
| Modulus 50 (psi) (kPa) | 29.29 | 27.752 | 29.451 |
| | (201.95) | (191.35) | (203.06) |
| Modulus 100 (psi) (kPa) | 33.139 | 32.075 | 34.745 |
| | (228.49) | (211.16) | (239.57) |
| Modulus 150 (psi) (kPa) | 36.53 | 35.641 | 38.42 |
| | (251.87) | (245.74) | (264.91) |

RT means Room temperature. In the above example the samples were cured for 7 days at room temperature prior to cold storage. Cold storage only took place for 8 days. For a non-slump product a slump of less than 0.2 inches (0.5 cm) in accordance with ASTM-D2202 is desirable. In the present example both comp 3 and example 3 have equally low slump values but example 3 has the added advantage of not have the environmentally unfriendly solvent absent. It will be noted that this is seen comp 3 which contains DMF solvent and both have a smooth cold appearance unlike comp 4 which is grainy in appearance due to the partial crystallization. FIG. 2a shows a cured sample of comp 4 (no DMF present) showing the grainy appearance due to the crystallization effect after cold storage: for 8 days @−30° C. FIGS. 2b and 2c show cured samples of Ex. 3 in accordance with the invention and Comp 3 (which includes DMF) showing smooth appearance after cold storage for 8 days @−30° C.

No separation is seen in example 3 in accordance with the present invention unlike comparatives 3 and 4. This indicates a further advantage for the composition in accordance with the present invention in that the composition in accordance with the present invention maintains better and longer lasting filler dispersion in the composition. It will be noted that over a short period of cold storage, the significant difference seen in elongation seen after long term storage in Example 1 is not observed.

TABLE 2e
“Cold storage: 92 d @ −30° C.”

| Initial | Comp 3 | Comp 4 | Example 3 |
|---|---|---|---|
| Cold appearance | smooth | grainy | smooth |
| Initial separation | yes - clear fluid | none | none |
| Slump (in) | 0.05 | 0.3 | 0.05 |

In Table 2e further samples of comparatives 3 and 4 and example 3 were cured in the same manner and then kept in cold storage for an extended period of 92 days at a temperature of −30° C. Again example 3 gave the best results overall, as it provided a smooth appearance, had no initial separation visible and still had a good slump value.

1. A silicone elastomer composition which is storage stable, at temperatures of 5° C. or below, in the absence of moisture but curable at room temperature, upon exposure to moisture, to a silicone elastomer, the composition comprising a mixture of the following ingredients prepared by mixing under anhydrous conditions:
(i) 100 parts by weight of a hydroxyl endblocked polydiorganosiloxane having a viscosity at 25° C., of from 5 to 100 Pa·s and in which the organic groups are selected from the group consisting of methyl, ethyl, vinyl, phenyl, and 3,3,3-trifluoropropyl radicals, with the provisos that no more than 50% of the organic groups are phenyl radicals or 3,3,3-trifluoropropyl radicals and no more than 10% of the organic groups are alkenyl radicals,
(ii) one or more fillers, optionally treated to be rendered hydrophobic,
(iii) from 2.5 to 10 parts by weight of methylvinyldi(N-ethylacetamido)silane,
(iv) from 1 to 6 parts by weight of an aminoxysilicon compound having from 1 to 100 silicon atoms per molecule and from 3 to 10 aminoxy groups per molecule, the aminoxy group having a general formula —OX in which:
X is a monovalent amine radical selected from the group consisting of —NR₂ and a heterocyclic amine and R is a monovalent hydrocarbon radical,
the —OX group being bonded to silicon atoms through an SiO bond, the remaining valences of the silicon atoms in the aminoxysilicon compound being satisfied by divalent oxygen atoms which link the silicon atoms of the aminoxysilicon compounds having two or more silicon atoms per molecule through silicon-oxygen-silicon bonds, and by monovalent hydrocarbon radicals and halogenated monovalent hydrocarbon radicals bonded to the silicon atoms through silicon-carbon bonds, there being an average of at least one monovalent hydrocarbon radical or halogenated monovalent hydrocarbon radical per silicon atom;
wherein the composition contains no parts of a polar solvent selected from N,N-dimethylformamide (DMF), acetonitrile and N-n-butylacetamide.

2. The composition in accordance with claim 1 in which the hydroxyl endblocked polydiorganosiloxane is a polydimethylsiloxane having a viscosity at 25° C. of from about 5 to 100 Pa·s.

3. The composition in accordance with claim 1 wherein the filler comprises one or more of the following, high surface area fumed and precipitated silicas, calcium carbonate, crushed quartz, diatomaceous earths, barium sulphate, iron oxide, titanium dioxide, carbon black, talc, wollastonite, aluminite, calcium sulphate (anhydrite), gypsum, calcium sulphate, magnesium carbonate, clays, aluminium trihydroxide, magnesium hydroxide (brucite), graphite, copper carbonate, nickel carbonate, barium carbonate, strontium carbonate, aluminium oxide, or silicates.

4. The composition in accordance with claim 1 wherein the filler is partially or completely treated with a hydrophobing treating agent selected from fatty acid, fatty acid ester, stearic acid, salts of stearic acid, carboxylatepolybutadiene, organosilanes, organosiloxanes, or organosilazanes hexaalkyl disilazane or short chain siloxane diols.

5. The composition in accordance with claim 1 in which the filler is selected from calcium carbonate treated with calcium stearate and/or ground calcium carbonate.

6. The composition in accordance with claim 1 in which the aminoxysilicon compound is a copolymer having per molecule an average of two trimethylsiloxane units, 2 to 20 methyl (N,N-diethylaminoxy)siloxane units and 2 to 20 dimethylsiloxane units per molecule.

7. The composition in accordance with claim 6 in which the aminoxysilicon compound is a copolymer having an average of two trimethylsiloxane units, five methyl(N,N-diethylaminoxy)siloxane units and three dimethylsiloxane units per molecule.

8. The composition in accordance with claim 4 further comprising a trimethylsilyl endblocked polydimethylsiloxane diluent having a viscosity of above 12 Pa·s at 25° C.

9. The composition in accordance with claim 1 in which the polydimethylsiloxane is a blend of polydimethylsiloxanes of various viscosities.

10. (canceled)

11. A method of preparing a composition in accordance with claim 1, the method comprising mixing under anhydrous conditions ingredients (i), (ii), (iii) and (iv) to obtain a homogeneous mixture, and placing the obtained composition in a storage container to exclude moisture from contacting this composition and maintain this composition under an essentially anhydrous condition.

12. A method of preparing a composition in accordance with claim 11 in which ingredients (i) and (ii) are mixed into a homogeneous mixture before the introduction of the remaining ingredients.

13. A method of preparing a composition in accordance with claim 11 in which the aminoxysilicon compound is mixed with the homogeneous mixture before the introduction of ingredient (iii), or in which a mixture comprising ingredients (iii) and (iv) is added to the homogeneous mixture.

14. (canceled)

15. The method of preparing a composition in accordance with claim 11 in which the resulting composition is exposed to moisture by removing it from the storage container.

16. A method of producing a cured silicone elastomer with a surface coated with a hardened protective coating, the method comprising exposing a composition in accordance with claim 1 to moisture until a cured elastomeric surface is obtained and a homogeneous dull surface develops, thereafter applying a water based protective coating composition, hardenable at ambient conditions, over at least a portion of the cured elastomeric surface where the protective coating composition wets the surface to which it is applied and produces an essentially flaw-free film and, thereafter, allowing the protective coating composition to harden.

17. A method of sealing a space between two units, the method comprising applying a composition according to claim 1 into or onto the space, and causing or allowing the composition to cure.

18. (canceled)

19. The composition in accordance with claim 1 which does not visibly partially crystallize when stored at a temperature of 5° C. or less
